(19) United States
(12) Patent Application Publication
(10) Pub. No.: US 2026/0023490 A1
(43) Pub. Date: Jan. 22, 2026

(54) COMPUTER HARDWARE SYSTEM AND ARTIFICIAL INTELLIGENCE COMPUTING PROCESS

(71) Applicant: SUNPLUS TECHNOLOGY CO., LTD., Hsinchu County (TW)

(72) Inventors: CHAO-WANG WU, Hsinchu County (TW); MIN-FU KAO, Hsinchu County (TW); KUN-YUAN CHAO, Hsinchu County (TW)

(21) Appl. No.: 19/266,551

(22) Filed: Jul. 11, 2025

(30) Foreign Application Priority Data
Jul. 17, 2024 (TW) 113126792

(51) Int. Cl. G06F 3/06

(52) U.S. Cl. CPC G06F 3/0631; G06F 3/061; G06F 3/0655; G06F 3/0683

(57) ABSTRACT

A computer hardware system for executing an artificial intelligence (AI) computing process is provided. The computer hardware system includes a primary storage device, a primary processor, a secondary storage device, and at least one accelerator processor. The primary storage device is configured to store write-intensive data. The primary processor is connected to the primary storage device and is configured to execute a setup process in the artificial intelligence computing process. The secondary storage device is configured to store read-intensive-and-no-write-intensive data. The at least one accelerator processor is configured to load the read-intensive-and-no-write-intensive data stored in the secondary storage device and access the write-intensive data in the primary storage device through the primary processor.

### CROSS-REFERENCE TO RELATED APPLICATION AND CLAIM OF PRIORITY

This application claims the benefit of Taiwan Patent Application No. 113126792, filed on Jul. 17, 2024, at the Taiwan Intellectual Property Office, the disclosures of which are incorporated herein in their entirety by reference.

### FIELD OF THE INVENTION

The present disclosure is related to artificial intelligence technology, and more particularly to a computer hardware system and an artificial intelligence computing process executed by the computer hardware system, which utilizes resource sharing to effectively improve the performance and stability of the computer hardware system and extend the service life of the computer hardware system.

### BACKGROUND OF THE INVENTION

With the rapid development of artificial intelligence (AI) technology, the application range thereof continuously expands from image recognition and speech recognition to natural language processing and other fields, and thus the progress of the AI technology is changing our lives. However, these technologies rely on huge computing resources and storage space. The training and predicting process of AI computing requires a large number of memories to store the parameter data of the AI model and the cache data generated during the computation, which not only increases the cost of the equipment, but also the management and optimization of computing resources. In such situation, resource sharing becomes an important way to solve the problem.

First, it is needed to understand the demand for memory in AI computing. Modern AI models, such as deep neural networks, usually contain millions or even billions of parameters. These parameters need to be stored in the memory for fast accessing and updating during training and predicting. In addition, a large amount of intermediate data (i.e., cache data) is generated during the computation process, which also needs to be stored in the memory during the computation process. For example, training a large natural language processing model (such as GPT-3) may require hundreds of GB or even several TB of memory space.

When sharing resources, in addition to the management and allocation of the computing resources, the characteristics of different memory devices also need to be considered. Solid-state drives (SSDs), such as NAND flash, have a limited number of read and write cycles, wherein long-time and high-frequency read and write operations will deplete memory resources and shorten the life of these devices. Therefore, in the process of resource sharing, the properties of these devices need to be considered to ensure the stability and long-term operation of the system.

Therefore, to provide a computer hardware system and an artificial intelligence computing process executed by the computer hardware system is urgently required, just as it is necessary to effectively improve the performance and stability of the computer hardware system at a lower cost and extend the service life of the computer hardware system by using resource sharing.

### SUMMARY OF THE INVENTION

One object of the present invention is to provide a computer hardware system for executing an artificial intelligence computing process, which solves the problem of insufficient memory space in a relatively low-cost manner by means of resource sharing, and also improves the performance and stability of the computer hardware system, which is particularly important for AI computing that requires intensive processing of large-scale data.

In order to achieve the above-mentioned object, in one aspect of the present invention, the present invention provides a computer hardware system for executing an artificial intelligence computing process, and the computer hardware system includes: a primary storage device, a primary processor, a secondary storage device, and at least one accelerator processor. The primary storage device is configured to store instructions and write-intensive cache data for executing the artificial intelligence computing process. The primary processor is connected to the primary storage device and is configured to execute a setup process in the artificial intelligence computing process, and access the write-intensive cache data in the primary storage device. The secondary storage device is configured to store read-intensive-and-no-write-intensive data including an artificial intelligence model data. The at least one accelerator processor is connected to the secondary storage device and the primary processor. The at least one accelerator processor is configured to load artificial intelligence model data stored in the secondary storage device, execute a plurality of layer computations in the artificial intelligence computing process based on the artificial intelligence model data, and access cache data in the primary storage device through the primary processor. The setup process executed by the primary processor comprises the following steps: defining the plurality of layer computations and assigning the plurality of layer computations to the at least one accelerator processor; inputting data and preprocessing the data; and importing the preprocessed data to the plurality of layer computations.

In another aspect of the present invention, the present invention further provides an artificial intelligence computing process executed by a computer hardware system, wherein the computer hardware system includes a primary storage device, a primary processor, a secondary storage device, and at least one accelerator processor. The artificial intelligence computing process includes: using the primary processor to access write-intensive instructions in the primary storage device to execute a setup process; loading read-intensive-and-no-write-intensive data including artificial intelligence model data from the secondary storage device to at least one accelerator processor; and using at least one accelerator processor to execute multiple layer computations in the artificial intelligence computing process and access cache data in the primary storage device through the primary processor based on the artificial intelligence model data. The setup process comprises the following steps: defining the plurality of layer computations and assigning the plurality of layer computations to the at least one accelerator processor; inputting data and preprocessing the data; and importing the preprocessed data to the plurality of layer computations.

In another aspect of the present invention, the present invention further provides a computer hardware system for executing an artificial intelligence computing process, and the computer hardware system includes: a primary storage device, a primary processor, a secondary storage device, and at least one accelerator processor. The primary storage device is configured to store write-intensive data. The primary processor is connected to the primary storage device and is configured to execute a setup process in the artificial intelligence computing process. The secondary storage device is configured to store read-intensive-and-no-write-intensive data. The at least one accelerator processor is configured to load the read-intensive-and-no-write-intensive data stored in the secondary storage device and execute multiple layer computations in the artificial intelligence computing process based on the read-intensive-and-no-write-intensive data, and access the write-intensive data in the primary storage device through the primary processor. The setup process executed by the primary processor comprises the following steps: defining the plurality of layer computations and assigning the plurality of layer computations to the at least one accelerator processor; inputting data and preprocessing the data; and importing the preprocessed data to the plurality of layer computations.

In summary, the computer hardware system of the present invention and the artificial intelligence computing process executed by the computer hardware system effectively improve the performance and stability of the computer hardware system by means of resource sharing, and extend the service life of the computer hardware system.

### BRIEF DESCRIPTION OF THE DRAWINGS

The above-mentioned objects and advantages of the present invention will become more obvious to those having ordinary knowledge in the technical field after referring to the following detailed description and the accompanying drawings.

FIG. 1 is a schematic diagram of a computer hardware system of a specific embodiment of the present invention for executing an artificial intelligence computing process under an artificial intelligence operating system.

FIG. 2 is a flow chart of an artificial intelligence computing process of a specific embodiment of the present invention.

FIG. 3 is a flow chart of a setup process of an artificial intelligence computing process of a specific embodiment of the present invention.

FIG. 4 is a flow chart of a setup process of an artificial intelligence computing process of another specific embodiment of the present invention.

### DETAILED DESCRIPTION OF THE PREFERRED EMBODIMENTS

Please read the following detailed description with reference to the accompanying drawings of the present disclosure. The accompanying drawings of the present disclosure are provided by way of example to introduce various different embodiments of the present disclosure and to help understand how to implement the present disclosure. The embodiments of the present disclosure provide sufficient content for those skilled in the art to implement the embodiments disclosed by the present disclosure or to implement embodiments derived from the content disclosed by the present disclosure. It should be noted that the embodiments are not mutually exclusive, and some embodiments can be appropriately combined with one or more other embodiments to form new embodiments, that is, the implementation of the present disclosure is not limited to the embodiments disclosed below. In addition, for the sake of simplicity and clarity of illustration, the relevant details will not be excessively disclosed in each embodiment. Even the specific details disclosed are only used as examples to help understand, and the relevant specific details in each embodiment are not used to limit the disclosure of the present application.

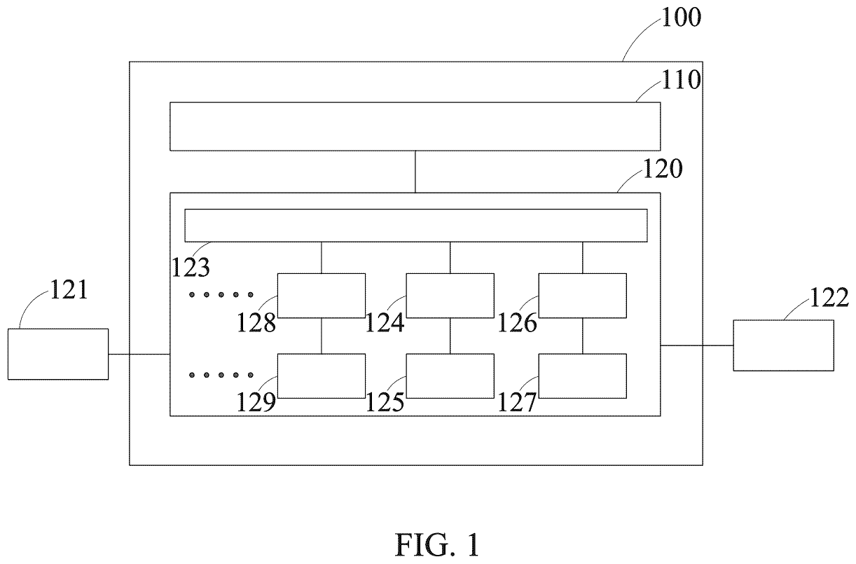

Referring to FIG. 1, it is a schematic diagram of a computer hardware system of a specific embodiment of the present disclosure for executing an artificial intelligence computing process under an artificial intelligence operating system. In FIG. 1, in the environment of an artificial intelligence operating system 100, a computer hardware system 120 is provided to execute an artificial intelligence computing process 110, and the computer hardware system 120 includes a primary processor 124, a primary storage device 125, at least one accelerator processor 128 and a secondary storage device 127. The primary storage device 125 is configured to store instructions and cache data for executing the artificial intelligence computing process 110. The primary processor 124 is connected to the primary storage device 125 and is configured to execute a setup process in the artificial intelligence computing process 110.

In a specific embodiment, the artificial intelligence computing process 110 can be an artificial intelligence predicting application or an artificial intelligence training application. For example, when performing the artificial intelligence computing process 110 of the artificial intelligence predicting application, the primary processor 124 can be used to execute the setup process. Specifically, the primary processor 124 first defines the plurality of layer computations of the model and assigns the plurality of layer computations to the at least one accelerator processor 128. Next, data is input from the input terminal 121, and the primary processor 124 preprocesses the data, such as standardization, normalization, feature extraction or cleaning, to ensure that the data is suitable for the input format of the model. Then, the preprocessed data is imported into the plurality of layer computations defined in the model. After completing the setup process, the artificial intelligence model data is loaded from the secondary storage device 127 to the at least one accelerator processor 128. Since the existing artificial intelligence model data usually contains millions or even billions of parameters, in this specific embodiment, these parameters are mainly stored in the secondary storage device 127, which is implemented with a solid-state drive (SSD), a hard disk (HDD), a NOR flash, an RRAM, or an FRAM, preferably a NAND flash. However, the solid-state drive has a limit on the number of read and write cycles. Long-time and high-frequency read and write operations will damage the solid-state drive and shorten the lifespan thereof. Therefore, in the present invention, the secondary storage device 127 is mainly used to store read-intensive-and-no-write-intensive data, making full use of the advantages of large capacity and low cost of SSD, while avoiding the disadvantages of limited write times. In a specific example, the read-intensive-and-no-write-intensive data includes the artificial intelligence model data.

Then, the at least one accelerator processor 128 executes the plurality of layer computations in the artificial intelligence computing process 110 based on the artificial intelligence model data, and accesses cache data in the primary storage device 125 through the primary processor 124. Finally, the computer hardware system 120 outputs the results of the artificial intelligence predicting application to the output terminal 122. In this specific embodiment, these cache data are mainly stored in the primary storage device 125, which is implemented with memory such as DRAM, SRAM, MRAM, etc. However, although such storage devices are relatively expensive, they can withstand high-frequency and long-time write operations. Therefore, in the present invention, the primary storage device 125 is mainly used to store write-intensive data which is used for advantages of durability and fast response. In a specific example, the write-intensive data includes the instructions and the cache data for executing the artificial intelligence computing process. By allocating memory resources for different operations of the present invention, not only the data processing efficiency but also the efficiency of the artificial intelligence computing process is improved.

As described above, in a specific embodiment, the artificial intelligence computing process 110 can be the artificial intelligence predicting application or the artificial intelligence training application. For example, when performing the artificial intelligence computing process 110 of the artificial intelligence training application, the primary processor 124 can be used to execute the setup process. Specifically, the primary processor 124 first defines the plurality of layer computations of the model and assigns the plurality of layer computations to the at least one accelerator processor 128. Then, before the model training, data is input from the secondary storage device 127, and the primary processor 124 preprocesses the data, such as standardization, normalization, feature extraction or cleaning, to ensure that the data is suitable for the input format of the model. Then, the iteration parameters of the model training are set, that is, the number of times the model is trained on the entire data set, or called an epoch. A certain number of iterations is usually set to ensure that the model is fully learned. After completing the setup process, the artificial intelligence model data is loaded from the secondary storage device 127 to the at least one accelerator processor 128. Since existing artificial intelligence model data usually contains millions or even billions of parameters, in this specific embodiment, these parameters are mainly stored in the secondary storage device 127, which uses a solid-state drive (SSD), a hard disk (HDD), a NOR flash, an RRAM, or an FRAM, preferably a NAND flash. However, the solid-state drive has a limited number of read and write cycles. Long-time and high-frequency read and write operations will cause damage on the solid-state drive and shorten the lifespan thereof. Therefore, in the present invention, the secondary storage device 127 is mainly used to store read-intensive-and-no-write-intensive data, making full use of the advantages of large capacity and low cost of SSD, while disadvantage of limited write times is avoided. In a specific example, the read-intensive-and-no-write-intensive data includes the artificial intelligence model data.

Then, the at least one accelerator processor 128 executes the plurality of layer computations in the artificial intelligence computing process 110 based on the artificial intelligence model data, and accesses cache data in the primary storage device 125 through the primary processor 124. Finally, the computer hardware system 120 outputs the results of the artificial intelligence training application to the secondary storage device 127. In this specific embodiment, these cache data are mainly stored in the primary storage device 125, which is implemented with memory such as DRAM, SRAM, MRAM, etc. Although such storage devices are relatively expensive, they can withstand high-frequency and long-term write operations. Therefore, in the present invention, the primary storage device 125 is mainly used to store write-intensive data for advantages of durability and fast response. In a specific example, the write-intensive data includes the instructions and the cache data for executing the artificial intelligence computing process. By allocating memory resources for different operations of the present invention, not only the data processing efficiency but also the efficiency of the artificial intelligence computing process is improved.

In a specific embodiment, the computer hardware system 120 of the present invention may further include a storage controller 126 connected to the secondary storage device 127, wherein the storage controller 126 is configured to determine whether the at least one accelerator processor 128 accesses the secondary storage device 127.

In a specific embodiment, the computer hardware system 120 of the present invention may further include an accelerator storage device 129 connected to the at least one accelerator processor 128 for access by the at least one accelerator processor 128. In a specific embodiment, the accelerator storage device 129 may be regarded as an expansion of the primary storage device 125, that is, using a memory, such as DRAM, SRAM, MRAM, etc., to mainly store the write-intensive data for access by the at least one accelerator processor 128. In a specific embodiment, the write-intensive data includes the instructions and the cache data for executing the artificial intelligence computing process. In a specific embodiment, the accelerator storage device 129 can also be accessed by the primary processor 124 through the at least one accelerator processor 128 to fully achieve the effect of resource sharing.

In a specific embodiment, the primary processor 124, the storage controller 126, and the at least one accelerator processor 128 of the computer hardware system 120 of the present invention communicate with each other through a PCIe interface 123. However, it should be understood by those skilled in the art that the present invention is not limited to the use of the PCIe interface 123.

In a specific embodiment, the at least one accelerator processor 128 of the computer hardware system 120 of the present invention may be a GPU, an NPU, a TPU, an ASIC, etc., which may be directly connected to the respective accelerator storage device 129, or may access the write-intensive data in the primary storage device 125 through the primary processor 124 and access the read-intensive-and-no-write-intensive data in the secondary storage device 127 through the storage controller 126.

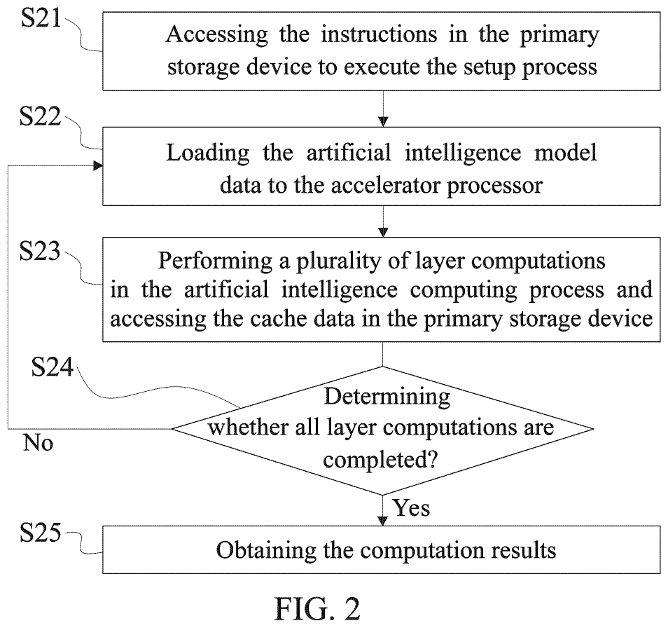

In conjunction with the computer hardware system 120 in FIG. 1, the present invention further provides an artificial intelligence computing process executed by the computer hardware system 120. The computer hardware system 120 includes a primary processor 124, a primary storage device 125, a secondary storage device 127, and at least one accelerator processor 128. Referring to FIG. 2, it is a flow chart of an artificial intelligence computing process of a specific embodiment of the present invention. In FIG. 2, the artificial intelligence computing process of the present invention includes the following steps. First, in step S21, the primary processor 124 accesses the instructions in the primary storage device 125 to execute the setup process.

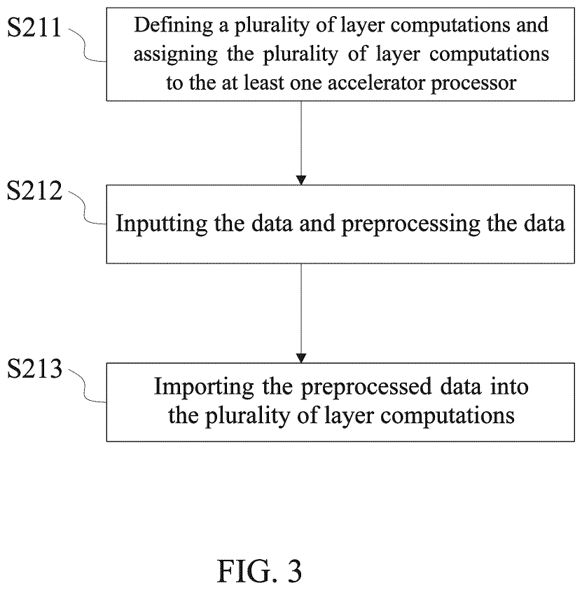

As mentioned above, the artificial intelligence computing process 110 can be the artificial intelligence predicting application. FIG. 3 is a flowchart of the setup process of the artificial intelligence computing process 110 of the artificial intelligence predicting application executed by the computer hardware system 120 of the present invention. In FIG. 3, step S211 is first executed, wherein the primary processor 124 first defines a plurality of layer computations of the model and assigns the plurality of layer computations to the at least one accelerator processor 128. Then, in step S212, data is input from the input terminal 121, and the primary processor 124 preprocesses the data, such as standardization, normalization, feature extraction or cleaning, to ensure that the data is suitable for the input format of the model. Then, in step S213, the preprocessed data is imported into the plurality of layer computations defined in the model.

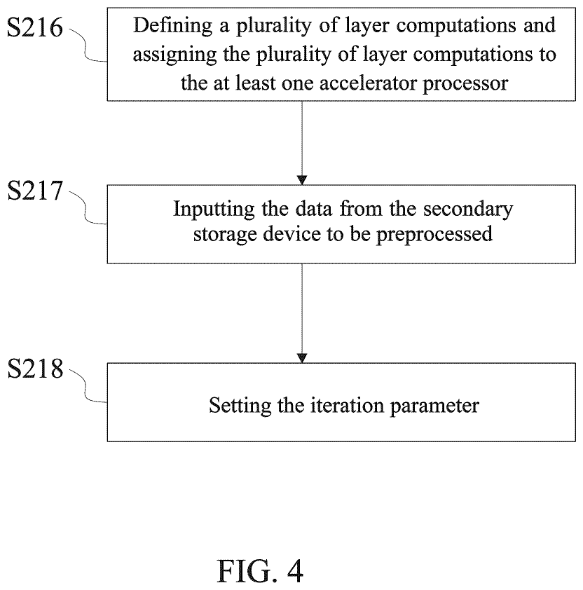

In another specific embodiment, the artificial intelligence computing process 110 can also be the artificial intelligence training application. FIG. 4 is a flow chart of the setup process of the artificial intelligence computing process 110 of the artificial intelligence training application executed by the computer hardware system 120 of the present invention. In FIG. 4, step S216 is first executed, wherein the primary processor 124 first defines a plurality of layer computations of the model and assigns the plurality of layer computations to the at least one accelerator processor 128. Then, in step S217, before the model training, data is input from the secondary storage device 127, and the primary processor 124 preprocesses the data, such as standardization, normalization, feature extraction or cleaning, to ensure that the data is suitable for the input format of the model. Then, in step S218, the iteration parameter of the model training is set, that is, the number of times the model is trained on the entire data set, or called an epoch. A certain number of iterations is usually set to ensure that the model is fully learned.

Then, in step S22, the artificial intelligence model data is loaded from the secondary storage device 127 to the at least one accelerator processor 128. Next, in step S23, based on the artificial intelligence model data, the at least one accelerator processor 128 performs the plurality of layer computations in the artificial intelligence computing process and accesses the cache data in the primary storage device 125 through the primary processor 124. In a specific embodiment, the at least one accelerator processor 128 can be directly connected to the accelerator storage device 129 for access by the at least one accelerator processor 128. In a specific embodiment, the accelerator storage device 129 can be regarded as an expansion of the primary storage device 125, that is, the memory, such as DRAM, SRAM, MRAM, etc., is used to mainly store the write-intensive data for access by the at least one accelerator processor 128. In a specific embodiment, the accelerator storage device 129 can also be accessed by the primary processor 124 through the at least one accelerator processor 128 to fully achieve the effect of resource sharing.

Next, in step S24, the primary processor 124 determines whether all layer computations have been completed. If so, the primary processor 124 will obtain computation results of the artificial intelligence computation process (step S25) and output the computation results from the output terminal 122 or store the computation results in the secondary storage device 127. If the primary processor 124 determines that all layer computations have not been completed, step S22 is executed again, wherein the artificial intelligence model data is loaded from the secondary storage device 127 to the at least one accelerator processor 128.

From the above discussion, it can be seen that the computer hardware system and the artificial intelligence computation process using the computer hardware system of the present invention solve the problem of insufficient memory space in a relatively low-cost manner by means of resource sharing, and improve the performance and stability of the computer hardware system, which is particularly important for AI computations that require intensive processing of large-scale data.

Although the present invention is disclosed as above by the above-mentioned several embodiments or examples, it is not intended to limit the present invention. Any person skilled in the art can make some changes and modifications without departing from the spirit and scope of the present invention. Therefore, the protection scope of the present invention shall be determined by the scope of the attached Claims.

1. A computer hardware system for executing an artificial intelligence computing process, comprising:
a primary storage device configured to store instructions and write-intensive cache data for executing the artificial intelligence computing process;
a primary processor connected to the primary storage device and configured to execute a setup process in the artificial intelligence computing process, and access the write-intensive cache data in the primary storage device;
a secondary storage device configured to store read-intensive-and-no-write-intensive data including artificial intelligence model data; and
at least one accelerator processor connected to the secondary storage device and the primary processor wherein the at least one accelerator processor is configured to load the artificial intelligence model data stored in the secondary storage device, executes multiple layer computations in the artificial intelligence computing process based on the artificial intelligence model data, and accesses the cache data in the primary storage device through the primary processor,
wherein the setup process executed by the primary processor comprises the following steps:
defining the plurality of layer computations and assigning the plurality of layer computations to the at least one accelerator processor;
inputting data and preprocessing the data; and
importing the preprocessed data to the plurality of layer computations.

2. The computer hardware system in claim 1, further comprising a storage controller connected to the secondary storage device and configured to determine whether the at least one accelerator processor accesses the secondary storage device.

3. The computer hardware system in claim 1, further comprising an accelerator storage device configured to be connected to the at least one accelerator processor for access by the at least one accelerator processor.

4. The computer hardware system in claim 2, wherein the primary processor, the at least one accelerator processor and the storage controller communicate with each other through a PCIe interface.

5. The computer hardware system in claim 1, wherein the setup process executed by the primary processor comprises the following steps:
defining the plurality of layer computations and assigning the plurality of layer computations to the at least one accelerator processor;
loading the preprocessed data from the secondary storage device; and
setting iteration parameters.

6. An artificial intelligence computing process executed by a computer hardware system, wherein the computer hardware system comprises a primary storage device, a primary processor, a secondary storage device, and at least one accelerator processor, and the artificial intelligence computing process comprises:
using the primary processor to access write-intensive instructions in the primary storage device to execute a setup process;
loading read-intensive-and-no-write-intensive data including artificial intelligence model data from the secondary storage device to the at least one accelerator processor; and
using the at least one accelerator processor to perform a plurality of layer computations in the artificial intelligence computing process and accessing cache data in the primary storage device through the primary processor based on the artificial intelligence model data,
wherein the setup process comprises the following steps:
defining the plurality of layer computations and assigning the plurality of layer computations to the at least one accelerator processor;
inputting data and preprocessing the data; and
importing the preprocessed data to the plurality of layer computations.

7. The artificial intelligence computing process in claim 6, further comprising:
using a storage controller to determine whether the at least one accelerator processor accesses the secondary storage device.

8. The artificial intelligence computing process in claim 6, further comprising a step of providing an accelerator storage device configured to be connected to the at least one accelerator processor for access by the at least one accelerator processor.

9. The artificial intelligence computing process in claim 7, wherein the primary processor, the at least one accelerator processor and the storage controller communicate with each other through a PCIe interface.

10. The artificial intelligence computing process in claim 6, wherein the setup process executed by the primary processor comprises the following steps:
defining the plurality of layer computations and assigning the plurality of layer computations to the at least one accelerator processor;
loading the preprocessed data from the secondary storage device; and
setting iteration parameters.

11. A computer hardware system for executing an artificial intelligence computing process, comprising:
a primary storage device configured to store write-intensive data;
a primary processor connected to the primary storage device and configured to execute a setup process in the artificial intelligence computing process;
a secondary storage device configured to store read-intensive-and-no-write-intensive data; and
at least one accelerator processor configured to load the read-intensive-and-no-write-intensive data stored in the secondary storage device and execute multiple layer computations in the artificial intelligence computing process based on the read-intensive-and-no-write-intensive data, and access the write-intensive data in the primary storage device through the primary processor,
wherein the setup process executed by the primary processor comprises the following steps:
defining the plurality of layer computations and assigning the plurality of layer computations to the at least one accelerator processor;
inputting data and preprocessing the data; and
importing the preprocessed data to the plurality of layer computations.

12. The computer hardware system in claim 11, wherein the write-intensive data comprises instructions and cache data for executing the artificial intelligence computing process.

13. The computer hardware system in claim 11, wherein the read-intensive-and-no-write-intensive data comprises artificial intelligence model data.

14. The computer hardware system in claim 11, further comprising a storage controller connected to the secondary storage device and configured to determine whether the at least one accelerator processor accesses the secondary storage device.

15. The computer hardware system in claim 11, further comprising an accelerator storage device configured to be connected to the at least one accelerator processor for access by the at least one accelerator processor.

16. The computer hardware system in claim 14, wherein the primary processor, the at least one accelerator processor and the storage controller communicate with each other through a PCIe interface.
